(19) United States
(12) Patent Application Publication
(10) Pub. No.: US 2011/0242298 A1
(43) Pub. Date: Oct. 6, 2011

(54) PRIVATE VIDEO PRESENTATION

(75) Inventors: Steven Bathiche, Kirkland, WA (US); Timothy Large, Bellevue, WA (US); Adrian Travis, Seattle, WA (US)

(73) Assignee: MICROSOFT CORPORATION, Redmond, WA (US)

(21) Appl. No.: 13/163,453

(22) Filed: Jun. 17, 2011

Related U.S. Application Data
(63) Continuation-in-part of application No. 12/621,275, filed on Nov. 18, 2009.
(60) Provisional application No. 61/235,928, filed on Aug. 21, 2009.

(51) Int. Cl. H04N 13/04; H04N 9/12; H04N 5/60; H04N 7/18

(52) U.S. Cl. 348/54; 348/739; 348/738; 348/77; 348/E13.074; 348/E07.085; 348/E05.125; 348/E09.012

(57) ABSTRACT

Embodiments are disclosed that relate to private video presentation. For example, one disclosed embodiment provides a system including a display surface, a directional backlight system configured to emit a beam of light from the display surface and to vary a direction in which the beam of light is directed, and a spatial light modulator configured to form an image for display via the directional backlight system. The system further includes a controller configured to control the optical system and the light modulator to display a first video content item at a first viewing angle and a second video content item at a second viewing angle.

### CROSS-REFERENCE TO RELATED APPLICATIONS

This application is a continuation-in-part of U.S. patent application Ser. No. 12/621,275, filed on Nov. 18, 2009 and entitled “SCANNING COLLIMATION OF LIGHT VIA FLAT PANEL LAMP,” which claims priority to U.S. Provisional Application Ser. No. 61/235,928, filed Aug. 21, 2009 and entitled “SCANNING COLLIMATION OF LIGHT VIA FLAT PANEL LAMP,” the entire disclosures of which are herein incorporated by reference.

### BACKGROUND

Many lamps comprise a source of light within a housing that is configured to concentrate the light in a desired direction. For example, in the case of a searchlight or light house, the concentration is such that the light may be said to be collimated, in that rays emerge from the light in parallel. In many cases, it is also desirable that the direction of light can be scanned. This may be done with conventional lamps, for example, by rotating the whole lamp, or rotating the lens and mirror around the source of light. However, such scanning mechanisms may not be suitable for use in some devices, such as display devices, due to geometric and other factors.

### SUMMARY

Various embodiments are disclosed herein that relate to providing private video presentations to one or more users. For example, one disclosed embodiment provides a video presentation system, comprising, a display surface, a directional backlight system configured to emit a beam of light from the display surface and to vary a direction in which the beam of light is directed, and a spatial light modulator configured to form an image for display via light from the directional backlight system. The system further comprises a controller configured to control the directional backlight system and the spatial light modulator to display a first video content item at a first viewing angle and a second video content item at a second viewing angle.

This Summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a video presentation system configured to display an image to one or more viewers via directed light.

FIG. 2 is a schematic, plan view showing an embodiment of an optical wedge.

FIGS. 3 and 4 show ray traces through a sectional view of the embodiment of FIG. 2.

FIG. 5 shows a schematic, magnified cross-sectional view of an end reflector of the embodiment of FIG.

FIGS. 6 and 7 show ray traces through the embodiment of FIG. 2 as paths through a stack of replicates of the embodiment of FIG. 2.

FIGS. 8 and 9 illustrate the scanning of directed light by injection of light into the optical wedge of FIG. 2 at different locations along a thin end of the optical wedge.

FIG. 10 shows a flowchart illustrating an embodiment of a method of scanning directed light.

FIG. 11 shows a flow-chart illustrating an embodiment of a method of using directed light to display public and private information using different modes on a display device.

FIG. 12 shows a flowchart illustrating an embodiment of a method for using directed light to display autostereoscopic images.

FIG. 13 shows an embodiment of a light injection system comprising a plurality of light sources.

FIG. 14 shows an embodiment of a light injection system comprising a single mechanically scannable light source.

FIG. 15 shows an embodiment of a light injection system comprising an acousto-optic modulator, a laser, and a diffusive screen.

FIG. 16 shows a flowchart illustrating an embodiment of a method of using directed light to display different private video presentations to different viewers concurrently.

### DETAILED DESCRIPTION

Various embodiments are disclosed herein related to the presentation of different images to different viewers that are concurrently viewing the same display screen. Some embodiments utilize a directional backlight, such as a flat-panel lamp, that allows an angle of a light beam emitted by the backlight to be varied to direct different images to different viewers, to different eyes of a viewer, etc. A flat panel lamp is a panel having a planar surface from which light is emitted. Such lamps may be used, for example, as backlights for liquid crystal display (LCD) panels. Some flat panel lamps may comprise, for example, a plurality of fluorescent light tubes contained within a housing that comprises a diffuser panel through which the light exits the panel. Other flat panel lamps may comprise an optical wedge to deliver light from a light source to a desired destination. An optical wedge is a light guide that permits light input at an edge of the optical wedge to fan out within the optical wedge via total internal reflection before reaching the critical angle for internal reflection and exiting the optical wedge. While the embodiments described herein are described in the context of scanning of directed light via a flat panel lamp, it will understood that other embodiments may employ hulk optics in a similar manner.

Current flat panel lamps are often used as diffuse light sources. However, in some situations, it may be desirable to emit directional light, whether collimated, diverging, or converging, from a flat panel lamp in a beam with a sufficiently narrow viewing angle to direct a specific image to one viewer such that the image may not be seen by other viewers sitting close by the viewer. For example, in some use environments, it may be desirable to display an image via an LCD panel such that the image may be seen only from certain angles, thereby keeping the displayed information private to intended viewers. The use of a directed beam of light to backlight an LCD panel may allow the construction of such a display, as an image on a display can only be seen if rays of light travel to a viewer's eye from the display. In the case of the use of a converging beam of light, a light beam may be configured to converge at a user's eye. In this manner, a substantial portion of the light used to produce an image may reach the user, thereby providing for the efficient use of power while maintaining the privacy of a presentation.

Further, with such a display, it may desirable that the direction of illumination can be scanned so that the angle at which the image is viewable may be moved. Additionally, if a direction of illumination can be rapidly switched back and forth between a pair of eyes or several pairs of eyes while the image on the liquid crystal panel is switched between one or several pairs of views of a three dimensional object, one can concurrently display different images to different users via a single display, display a three dimensional image to one or more users without the use of filtering glasses, and achieve other such use scenarios. Therefore, embodiments are disclosed herein related to directional image display systems including but not limited to flat panel lamps used as directional backlighting and that allow a direction of the light to be scanned. In the accompanying figures, it will be noted that the views of the illustrated embodiments may not be drawn to scale, and the aspect ratios of some features may be exaggerated to make selected features or relationships easier to see.

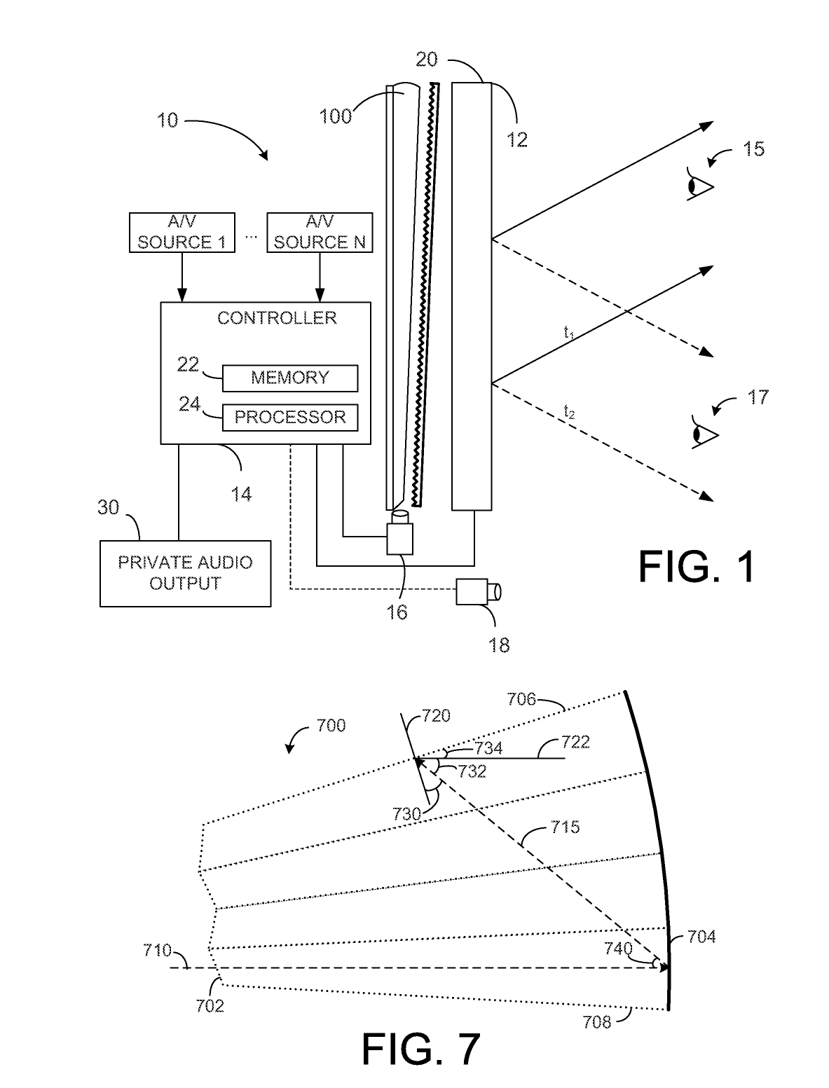

FIG. 1 shows an embodiment of a video presentation system in the form of a computing device comprising a display surface configured to output directed light. Video presentation system 10 includes spatial light modulator 12 and a light scanning system. Spatial light modulator 12 comprises an array of pixels each of which may be used to modulate light from the backlight with respect to color and intensity. In some embodiments, the spatial light modulator may comprise a liquid-crystal display device, but other light-modulating devices may be used as well. A controller, such as controller 14, may provide display data to spatial light modulator 12. When viewer 15 is in an optical path of the directed light, and the directed light has been modulated by spatial light modulator 12 with an image supplied from controller 14, the image may be visible by viewer 15.

Video presentation system 10 further comprises a light injection system 16, and an optical wedge 100. Some embodiments may further comprise an optional user tracking camera 18 and light redirector 20 disposed adjacent to a viewing surface of optical wedge 100. As described in more detail below, directed light is emitted from the viewing surface of optical wedge 100 when light is injected into a thin end of optical wedge 100. The directed light exits optical wedge 100 with a small angle, relative to the plane of the viewing surface of optical wedge 100. Light redirector 20 may be used to redirect the collimated light toward spatial light modulator 12. Any suitable structure may be used as light redirector 20. In some embodiments, light redirector 20 may comprise a film of prisms, for example.

Light injection system 16 may be configured to inject light into one or more locations along the thin end of optical wedge 100. By varying the location where light is injected into the thin end of optical wedge 100, the direction of light leaving the viewing surface of optical wedge 100 may be adjusted. By varying the direction of the light synchronously with the changing of images produced by the spatial light modulator, different images may be displayed to different viewers. Further, when modulated at a sufficiently high frequency, both images may appear to viewers to be continuously displayed, without any noticeable flicker. Thus, referring to FIG. 1, when a first image is directed to viewer 15, the first image may be visible by viewer 15 but not by viewer 17. This is indicated by the solid line ray traces of FIG. 1. Likewise, when a second image is directed to viewer 17, the second image may be viewable by viewer 17 but not viewer 15. This is indicated by the dashed-line ray traces of FIG. 1. While FIG. 1 is shown in the context of two viewers, it will be understood that private video presentations may be concurrently directed to any suitable number of viewers. It will further be understood that the terms “first” and “second” as used herein with reference to viewers, video presentations, images, and the like is merely for convenience in describing sets of two or more viewers, presentations, images, etc., and is not intended to be limiting in any manner.

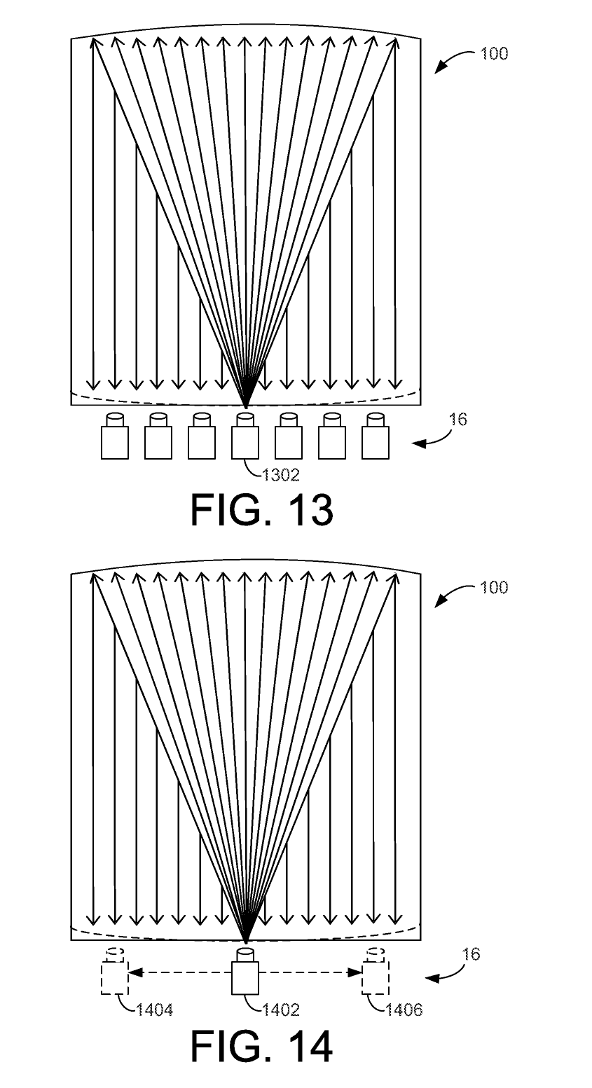

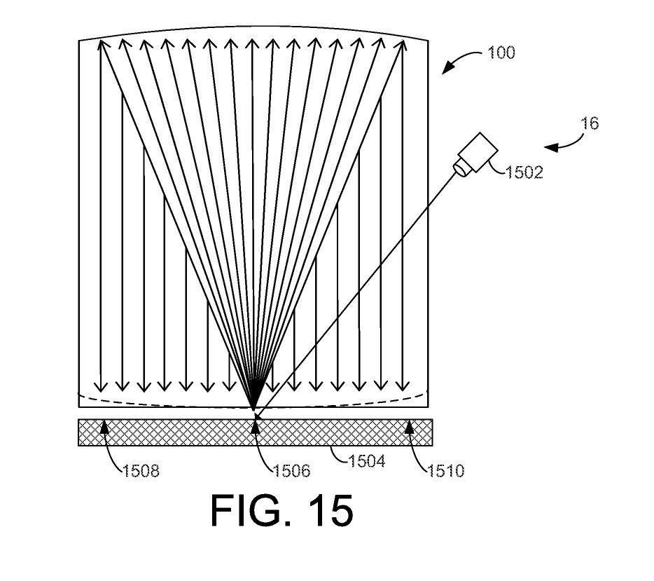

In one specific example embodiment illustrated in FIG. 13, light injection system 16 may comprise a plurality of individually controllable light sources, such as light emitting diodes (LEDs), lasers, lamps, and/or other suitable light sources, disposed adjacent to the thin end of optical wedge 100. Varying which light source is illuminated, or which light sources are concurrently illuminated, allows control for a direction in which directed light is emitted from optical wedge 100. For example, a single light source 1302 may be illuminated from the plurality of light sources in FIG. 13. Likewise, a plurality of light sources may be illuminated concurrently to direct multiple beams of an image in different directions. In other embodiments, such as illustrated in FIG. 14, a single mechanically scannable light source 1402 may be used to vary the location along the thin end of the optical wedge at which light is injected. The location of the light source may be varied from one side of optical wedge 100, such as location 1404, to the opposite side of optical wedge 100, such as location 1406. In yet another embodiment, such as illustrated in FIG. 15, light injection system 16 may comprise light source 1502 and diffusive screen 1504. Diffusive screen 1504 is positioned adjacent to and extending along the thin end of optical wedge 100. Light may be injected into the thin end of optical wedge 100 when a laser beam generated by light source 1502 is directed at diffusive screen 1504, and diffuse light is reflected off of diffusive screen 1504 into the thin end of optical wedge 100. Light source 1502 may include a laser and an acousto-optic modulator or a liquid crystal hologram for controlling the direction of the laser beam. The laser beam may be directed at location 1506, as shown, or the laser beam may be scanned from one side of diffusive screen 1504, such as location 1508, to the opposite side of diffusive screen 1504, such as location 1510.

Because the optical wedge 100 is configured to form directed light with a relatively narrow viewing angle, injecting light from a single location may enable directed light to be emitted in a single direction such that a projected image is viewable from only a narrow range of angles. This may allow information to be displayed in a private mode in which images are targeted to specific viewers. On the other hand, injecting light from more than one location concurrently may enable directed light to be emitted in more than one direction, which may allow a projected image to be viewable from a wider range of angles. Such a display mode may be referred to herein as a public mode. It will be understood that these examples of display modes are described for the purpose of illustration, and are not intended to be limiting in any manner.

Returning to FIG. 1, controller 14 may be configured to independently and selectively illuminate each light source of light injection system 16 according to a mode of the system. In such a manner, controller 14 may control the location along the thin end of the optical wedge at which light injection system 16 injects light. In addition, controller 14 may be configured to provide display data to spatial light modulator 12 and to receive data from a user tracking camera 18. The data from head-tracking camera 18 may be analyzed by controller 14 to determine the position of a viewer's head, eyes and/or other body part. The data from user tracking camera 18 may be raw image data, or the data may be pre-processed such that various features of the image are extracted before the data is transferred to controller 14. Any suitable image sensor or combination of sensors may be used with user tracking camera 18. For example, in some embodiments, two-dimensional image sensor may be used while in other embodiments, a depth sensor may be used. Likewise, in some embodiments, both a two-dimensional image sensor and a depth sensor may be used, in embodiments that utilize a depth sensor, any suitable depth sensing technology may be used, including but not limited to time-of-flight, structured light, and/or stereo image sensing, as well as body size, head size, etc. estimation algorithms that estimate depth based upon apparent body size in a two-dimensional image.

In some embodiments, controller 14 may also determine and store a mode for video presentation system 10 and control video presentation system 10 in accordance with that node. Controller 14 may be any computing device configured to execute instructions that may be stored in a computer readable storage medium, such as memory 22. Processor 24 may be used to execute instructions stored in memory 22, wherein the instructions include routines to carry out control methods for video presentation system 10.

Video presentation system 10 may further comprise a private audio output system 30 configured to provide private audio outputs corresponding to private video presentations. Private audio output system 30 may be configured to provide private audio outputs in any suitable manner. For example, in some embodiments, one or more sets of phased array speakers may be used to form audio beams directed at users. In such embodiments, user tracking camera 18 may be used to determine a direction for each audio beam. Where user tracking camera 18 comprises a depth camera or other depth-determining mechanism (e.g. apparent body/head size comparison), depth data may be utilized to determine a depth at which audio from a phased array speaker is configured to constructively interfere. In other embodiments, parabolic speakers or other directional speakers may be used to provide private audio outputs. As a more specific example, in an embodiment configured to support the viewing of two concurrent private video presentations, two parabolic speakers may be used to direct private audio to two viewers that are viewing different video content items. Such directional speakers may be configured to be moveable (e.g. by motors) to redirect audio output as a viewer physically moves around within a video viewing environment as detected by head-tracking, camera 18. In yet other embodiments, wireless or wired headphones may be utilized to provide private audio via a wireless communications system including a wireless transmitter. In the case of wireless headphones, any suitable mechanism may be used to associate a particular headphone set with a particular user, including but not limited to line-of-sight communications channels between headphone sets (e.g. infrared or other), and/or user inputs made in response to identification audio signals sent to each set of headphones.

Video presentation system 10 may be configured to obtain video content from any suitable source or sources. For example, in one specific embodiment video presentation system 10 may comprise plural television tuners to allow users to watch different television programs concurrently. In other embodiments, video presentation system 10 may receive inputs from any other sources or combination of sources, such as a MD player, computer network, video game system, etc. Such video inputs are illustrated in FIG. 1 as audio/video (“A/V”) source input 1, at and arbitrary A/V input N, at 42. Plural video content items received from multiple sources for concurrent presentation may be multiplexed in any suitable manner for provision to the spatial light modulator to enable the concurrent display of the plural video content items.

It will be understood that video presentation system 10 is described for the purpose of example, and that an optical system according to the present disclosure may be used in any suitable use environment. Further, it will be understood that a video presentation system such as that depicted in the embodiment of FIG. 1 may include various other systems and capabilities not illustrated, including but not limited to a vision-based or other touch detection system.

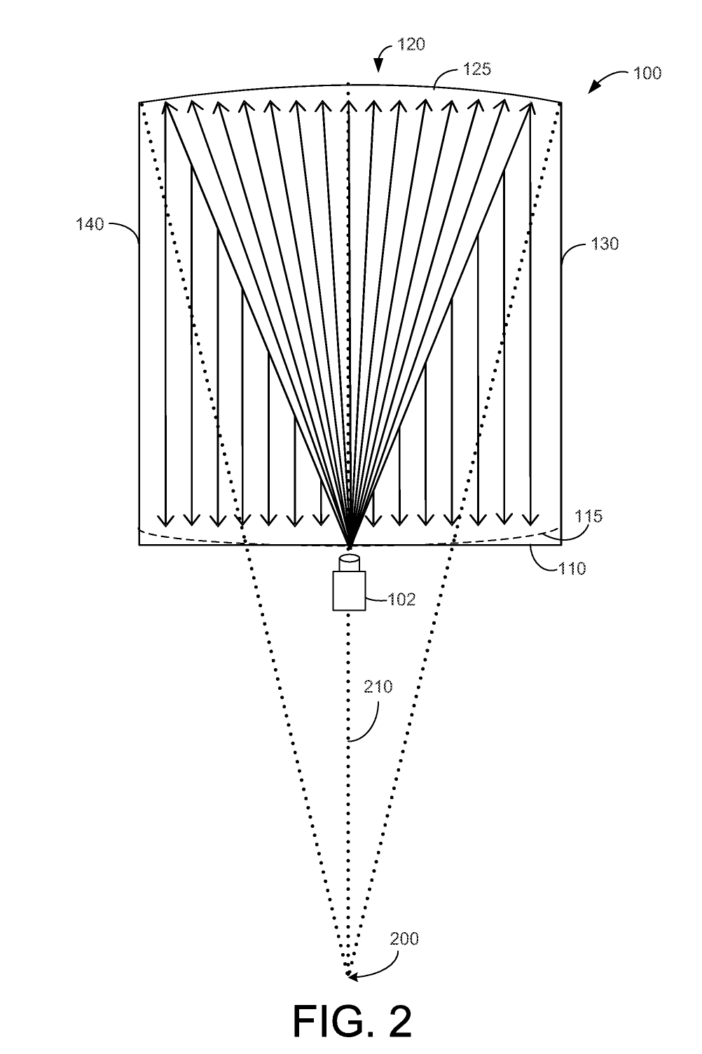

Referring next to FIG. 2, optical wedge 100 is configured to direct light from light source 102 disposed adjacent to a thin end 110 of optical wedge 100, such that directional light exits viewing surface 150 of optical wedge 100, as shown by the ray traces in FIG. 2. The term “viewing surface” indicates that viewing surface 150 is closer to a viewer than a back surface (not visible in FIG. 2) which is opposite of viewing surface 150. Each of the viewing and back surfaces is bounded by sides 130 and 140, thin end 110, and thick end 120. In FIG. 2, viewing surface 150 faces a viewer of the page and the back surface is hidden by this view of optical wedge 100.

Optical wedge 100 is configured such that light rays injected into a light interface of thin end 110 fan out via total internal reflection as they approach thick end 120 comprising end reflector 125. In the depicted embodiment, end reflector 125 is curved with a uniform radius of curvature having center of curvature 200, and light source 102 injecting light at the focal point of end reflector 125, the focal point being at one half the radius of curvature, thereby forming collimated light. In other embodiments, the light source may have any other suitable location to create any other desired light beam (e.g. converging or diverging). At thick end 120, each of the light rays reflects off of end reflector 125 parallel to each of the other light rays. The light rays travel from thick end 120 toward thin end 110 until the light rays intersect viewing surface 150 at a critical angle of reflection of viewing surface 150 and the light rays exit as directed light. In an alternative embodiment, end reflector 125 may be parabolic or have other suitable curvature and/or configuration for directing light.

In embodiments that comprise a plurality of light sources disposed adjacent to and along thin end 110, to correct for field curvature and/or spherical aberration, it may be desirable to slightly shorten sides 130 and 140 of optical wedge 100 so that a light source to either side of center line 210 may stay in the focal point of end reflector 125. Shortening sides 130 and 140 may make thin end 110 convex, as illustrated by curve 115. A suitable curvature may be found by using a ray-tracing algorithm to trace rays at a critical angle of reflection of viewing surface 150 of optical wedge 100 back through optical wedge 100 until the rays come to a focus near thin end 110.

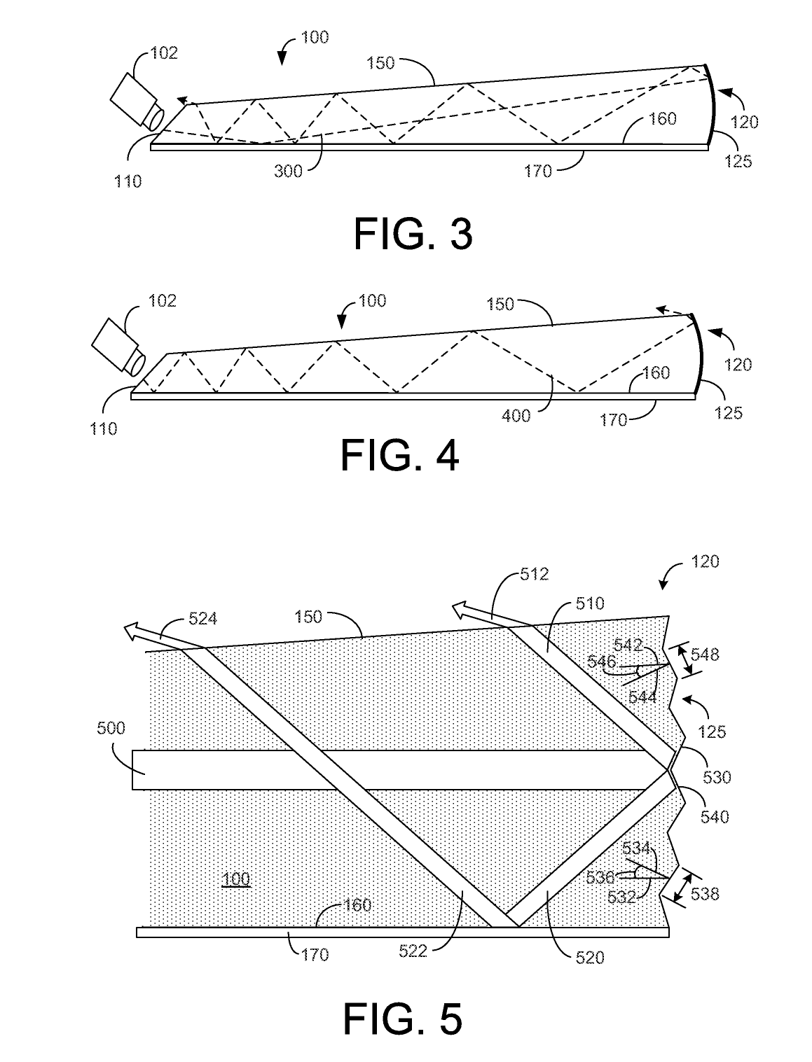

FIGS. 3 and 4 show ray traces through a schematic cross-sectional view of optical wedge 100. FIG. 3 shows the path of a first ray 300 through optical wedge 100, and FIG. 4 shows the path of a second ray 400 through optical wedge 100, wherein rays 300 and 400 represent rays located at opposite sides of a cone of light that is input into thin end 110 of optical wedge 100. As can be seen in FIGS. 3 and 4, ray 300 exits viewing surface 150 adjacent to thin end 110 of optical wedge 100, while ray 400 exits viewing surface 150 adjacent to thick end 120 of optical wedge 100.

Rays 300 and 400 exit viewing surface 150 once the rays 300 and 400 intersect viewing surface 150 at an angle less than or equal to a critical angle of internal reflection with respect to a normal of viewing surface 150. This critical angle may be referred to herein as the “first critical angle.” Likewise, rays reflect internally in optical wedge 100 when the rays intersect viewing surface 150 at an angle greater than the first critical angle of internal reflection with respect to the normal of viewing surface 150. Further, rays reflect internally in optical wedge 100 when the rays intersect back surface 160 at an angle greater than a critical angle of internal reflection with respect to the normal of hack surface 160. This critical angle may be referred to herein as the “second critical angle.”

As explained in more detail below with reference to FIG. 5, it may be desirable for the first critical angle and the second critical angle to be different, such that light incident on hack surface 160 at the first critical angle is reflected hack toward viewing surface 150. This may help to prevent loss of light through the back surface 160, and therefore may increase the optical efficiency of the optical wedge 100. The first critical angle is a function of the refractive index of optical wedge 100 and the index of refraction of the material interfacing viewing surface 150 (e.g. air or a layer of a cladding), while the second critical angle is a function of the refractive index of optical wedge 100 and the material adjacent to back surface 160. In some embodiments, such as that shown in FIGS. 3-4, a layer of cladding 170 may be applied only to hack surface 160, such that viewing surface 150 interfaces with air. In other embodiments, viewing surface 150 may comprise a layer of cladding (not shown) with a different refractive index than back surface 160.

Any suitable material or materials may be used as cladding layers to achieve desired critical angles of internal reflection for the viewing and/or back surfaces of an optical wedge. In an example embodiment, optical wedge 100 is formed from polymethyl methacrylate, or PMMA, with an index of retraction of 1.492. The index of refraction of air is approximately 1.000. As such, the critical angle of a surface with no cladding is approximately 42.1 degrees. Likewise, an example cladding layer may comprise Teflon AF (EI DuPont de Nemours & Co. of Wilmington, Del.), an amorphous fluoropolymer with an index of refraction of 1.33. The critical angle of a PMMA surface clad with Teflon AF is 63.0 degrees. It will be understood that these examples are described for the purpose of illustration, and are not intended to be limiting in any manner.

The configuration of optical wedge 100 and end reflector 125 may be configured to cause a majority of viewing surface 150 to be uniformly illuminated when uniform light is injected into thin end 110, and also to cause a majority of the injected light to exit viewing surface 150. As mentioned above, optical wedge 100 is tapered along its length such that rays injected at thin end 110 are transmitted to end reflector 125 via total internal reflection. End reflector 125 comprises a faceted lens structure configured to decrease the ray angle relative to a normal to each of viewing surface 150 and back surface 160. In addition, the diminishing thickness of optical wedge 100 from thick end 120 to thin end 110 causes ray angles to diminish relative to the normal of each surface as rays travel toward thin end 110. When a ray is incident on viewing surface 150 at less than the first critical angle, the ray will exit viewing surface 150.

In some embodiments, light source 102 may be positioned at a focal point of end reflector 125, while the light source 102 may be positioned at any other suitable location in other embodiments. In such embodiments, end reflector 125 may be curved with a radius of curvature that is twice the length of optical wedge 100. In the embodiment of FIGS. 3-4, the taper angle of optical wedge 100 is configured so that the corner at thick end 120 and viewing surface 150 comprises a right angle and the corner at thick end 120 and back surface 160 comprises a right angle. When thin end 110 is at the focal point of end reflector 125, thin end 110 is one half the thickness of thick end 120. In other embodiments, each of these structures may have any other suitable configuration.

In the depicted embodiment, end reflector 125 is spherically curved from side 130 to side 140 and from viewing surface 150 to back surface 160. In other embodiments, end reflector 125 may be cylindrically curved with a uniform radius of curvature from viewing surface 150 and back surface 160 and a center of curvature where viewing surface 150 and back surface 160 would meet if extended. A cylindrically curved end reflector may have less sag (i.e. curvature that is not useable as display area) than a spherically curved end reflector 125, which may be beneficial in large format applications. Other suitable curvatures may be used for end reflector 125, such as parabolic, for example. Additionally, the curvature of end reflector 125 in the plane perpendicular to sides 130 and 140 may differ from the curvature of end reflector 125 in the plane parallel to sides 130 and 140, such as a toroidal reflector.

As mentioned above, it may be desirable for the critical angles of reflection of viewing surface 150 and back surface 160 to be different to help prevent loss of light through back surface 160. This is illustrated in FIG. 5, which shows a schematic, magnified cross-sectional view of end reflector 125 of the embodiment of the optical wedge in FIGS. 2-4. End reflector 125 comprises a faceted lens structure comprising a plurality of facets arranged at an angle relative to a surface of thick end 120. The plurality of facets alternate between facets facing viewing surface 150, such as facet 530, and facets facing back surface 160, such as facet 540. End reflector 125 conforms to a general curvature as described above, with end reflector normal 542 and end reflector normal 532 extending toward the center of curvature. Each of the plurality of facets has a height and an angle relative to a normal of a surface of the end reflector. For example, one of the facets facing viewing surface 150 has a height 538 and an angle 536 relative to end reflector normal 532 and facet normal 534. As another example, one of the facets facing back surface 160 has a height 548 and an angle 546 relative to end reflector normal 542 and facet normal 544.

The height of each of the plurality of facets may affect the uniformity and the brightness of the light beam exiting viewing surface 150. For example, larger facets may create optical paths that differ from the ideal focal length, which may cause Fresnel banding. As such, in embodiments where such handing may pose issues, it may be desirable to make the height of each of the plurality of facets less than 500 microns, for example, so that such banding is less visible.

Likewise, the angle of each of the plurality of facets also may affect the uniformity and brightness of a directed light beam exiting viewing surface 150. Ray 500 illustrates how facet angles may affect the path of a ray through optical wedge 100. Ray 500 is injected into thin end 110, travel through optical wedge 100 and strikes end reflector 125. Half of ray 500 strikes facet 530 facing viewing surface 150. The portion of ray 500 striking facet 530 is reflected as ray 510 toward viewing surface 150. Ray 510 intersects viewing surface 150 at an angle less than or equal to the first critical angle of internal reflection with respect to a normal of viewing surface 150, and thus exits the viewing surface 150 as ray 512.

The other half of ray 500 strikes facet 540 facing back surface 160. The portion of ray 500 striking facet 540 is reflected as ray 520 toward back surface 160. Because of the difference between the critical angles of viewing surface 150 and back surface 160, ray 520 intersects back surface 160 at an angle greater than the second critical angle of internal reflection with respect to a normal of back surface 160, and thus reflects as ray 522 toward viewing surface 150. Ray 522 then intersects viewing surface 150 at an angle less than or equal to the first critical angle of internal reflection with respect to a normal of viewing surface 150, and thus exits as ray 524. In this manner a majority (and in some embodiments, substantially all) of the light that reflects from end reflector 125 exits viewing surface 150.

Due to light being separately reflected by facets facing viewing surface 150 and facets facing back surface 160, overlapping, superimposed first and second images arranged in a head-to-tail orientation are formed at viewing surface 150 when light is reflected from the back surface to exit the viewing surface. The degree of overlap between these images may be determined by the angles of the facets 530 and 540. For example, the two images are completely overlapping when each facet has an angle relative to a normal of a surface of the end reflector of three-eighths of a difference between ninety degrees and the first critical angle of reflection, as explained in more detail below. In this instance, substantially all light input into optical wedge 100 exits the viewing surface 150. Varying the facets from this value decreases the amount of overlap between images, such that only one or the other of the two images is displayed where the angles of the facets are ¼ or ½ of the difference between 90 degrees and the first critical angle of reflection. Further, varying the angles of the facets from three-eighths of the difference between ninety degrees and the first critical angle of reflection also causes some light to exit from the thin end of optical wedge 100, rather than from viewing surface 150. Where the angles of the facets are ¼ or ½ of the difference between 90 degrees and the first critical angle of reflection, the viewing surface also may be uniformly illuminated, but half of the light exits from the thin end of optical wedge 100, and is therefore lost. It will be understood that, depending upon the desired use environment, it may be suitable to use facet angles other than three-eighths of the difference between ninety degrees and the first critical angle of reflection. Such use environments may include, but are not limited to, environments in which any regions of non-overlapping light (which would appear to have a lower intensity relative to the overlapping regions) are not within a field of view observed by a user, as well as environments where diminished light intensity is acceptable.

In an alternative embodiment, the end reflector 125 may comprise a diffraction grating. The grating equation may be used to calculate an angle of diffraction for a given angle of incidence and a given wavelength of light. Since the angle of diffraction is dependent on the wavelength of the light, an end reflector comprising a diffraction grating may be desirable when the injected light is monochromatic.

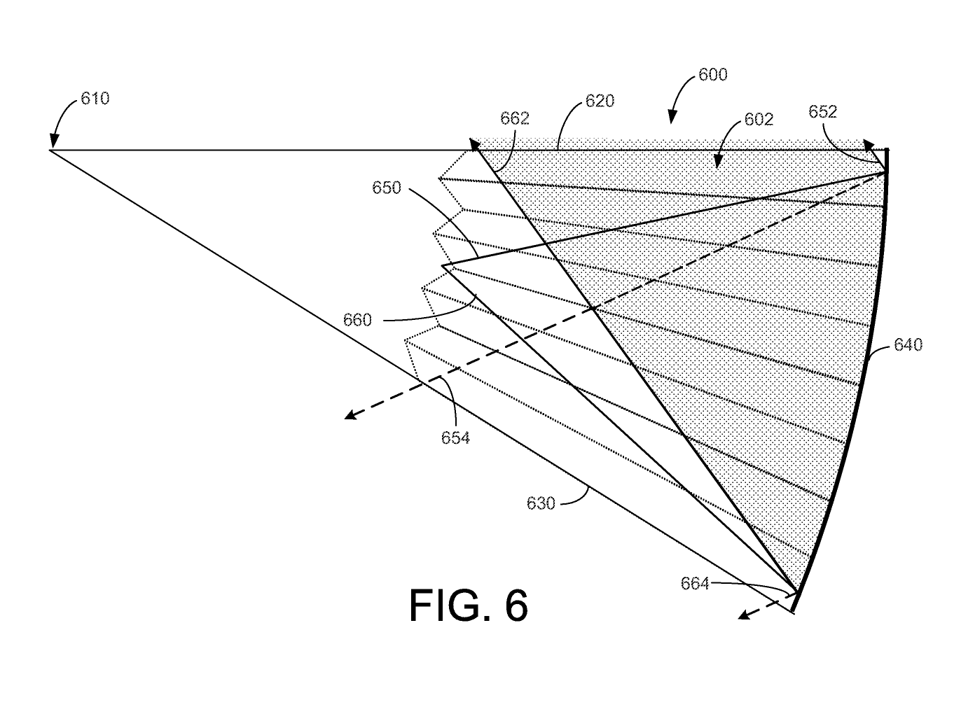

FIGS. 6 and 7 illustrate the travel of light through optical wedge 100 as paths of rays through a stack of optical wedges, each optical wedge being a replicate of the embodiment of optical wedge 100 to further illustrate the concepts shown in FIG. 5. Tracing rays through a stack of replicates of an optical wedge is optically equivalent to tracing a ray's path within an optical wedge. Thus, in this manner, each internal reflection of a ray is shown as the passage of the ray through a boundary from one optical wedge to an adjacent optical wedge. In FIG. 6, the viewing surface is shown as viewing surface 620 of a topmost wedge in the stack of optical wedges 600. The back surface is shown as back surface 630 of a bottommost wedge, in the stack of optical wedges 600. The thick ends of the stack of optical wedges 600 join to form what is approximately a curve 640 centered on the axis 610 where all the surfaces converge.

FIG. 6 also depicts two rays of light 650 and 660 located at opposite sides of a cone of light that is injected into a thin end of the optical wedge stack 600. For each ray 650 and 660, after reflection from the end reflector, half of the ray emerges near the thick end of the optical wedge stack 600 (and hence from the represented optical wedge), as shown by solid lines 652 and 662, and half of the ray emerges from the thin end of the optical wedge stack, as shown by dashed lines 654 and 664. Rays injected at any angle between these two extremes will also be split by the faceted pattern in the end reflector, and emerge from the viewing surface and back surface of the optical wedge in a similar manner. The rays exiting viewing surface 620 parallel to rays 652 and 662 are represented by shaded area 602. As mentioned above, it will be understood that rays shown as being emitted through back surface 630 of the optical wedge may instead be reflected by the back surface and then out of the viewing surface by utilizing a cladding (not shown) on the back surface of the optical wedge that has a lower refractive index than a cladding (not shown) utilized on a viewing surface of the optical wedge. In this manner, substantially all light that is injected into the thin end of such an optical wedge may be emitted from the viewing surface of the optical wedge.

For the viewing surface to be uniformly illuminated (e.g. where the images reflected from facets 530 and 540 are fully overlapping), a ray injected at the thin end and travelling horizontally toward the end reflector, coincident with a normal of the end reflector, reflects off of a facet facing the viewing surface and travels to the center of the viewing surface, intersecting the viewing surface at the critical angle of the viewing surface. FIG. 7 shows a schematic depiction of a path of such a ray through a stack of optical wedges 700. Ray 710 is injected at thin end 702 of the optical wedge and reflects off end reflector 704 as ray 715. Ray 715 travels to the center of viewing surface 706, intersecting viewing surface 706 at critical angle of reflection 730 relative to viewing surface normal 720. The sum of angles 732 and 734 is the difference of 90 degrees and critical angle of reflection 730. When the thin end of the optical wedge is one half the thickness of the thick end of the optical wedge, the center point of the wedge is three-fourths the thickness of the optical wedge. Using a paraxial approximation, angle 732 is three-fourths of the difference of 90 degrees and critical angle of reflection 730. Horizontal line 722 is parallel to injected ray 710 so angle 740 is equal to angle 732. From the law of reflection, the angle of incidence is equal to the angle of reflection so the facet angle may be one half of angle 740. Therefore, for the viewing surface to be uniformly illuminated, each facet facing the viewing surface may form an angle relative to a normal of a surface of the end reflector of three-eighths of a difference between 90 degrees and critical angle of reflection 730, as mentioned above.

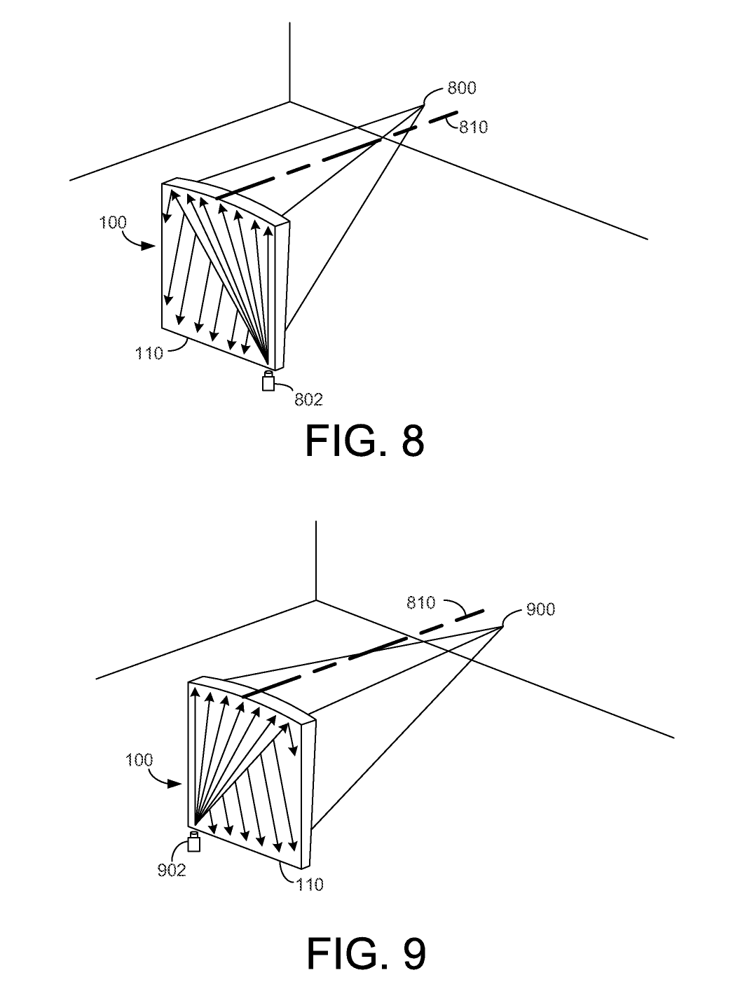

FIGS. 8 and 9 show how a direction of a directed beam of light may be varied by injecting light into the optical wedge of FIG. 2 at different locations along the thin end of the optical wedge. Specifically, the direction of the light beam may be moved to the left by shifting the location of light injection to the right, and vice versa, in each figure, the visible position of a single pixel of light, shown respectively at 800 and 900 in FIGS. 8 and 9, is illustrated for clarity. Further, lines are shown tracing from the point of light to the corners of the light interface of the optical wedge and centerline 810 is shown to illustrate movement of the pixel of light with respect to the optical wedge more clearly as the light injection location is moved.

In FIG. 8, light is injected from light source 802 at a first location into the right side of thin end 110. The direction of the light beam is directed toward the left of centerline 810 as illustrated by the pixel at visible position 800. In FIG. 9, light is injected from light source 902 at a second location into the left side of thin end 110. The direction of the light beam is directed to the right of centerline 810 as illustrated by the pixel at visible position 900. It will be understood that the light beam may be scanned, smoothly or in steps of any desired size and in any desired order, by sequentially changing the location of light injection along the thin side of optical wedge 100 at a desired time interval and in a desired order. Such a display mode may be referred to herein as a scanning mode.

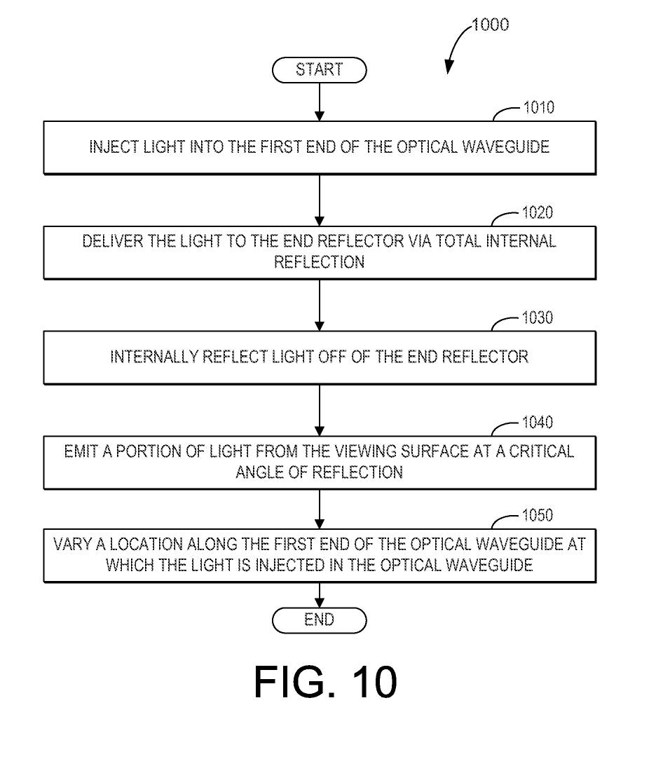

FIG. 10 shows a flowchart of an example method of scanning collimating light via an optical waveguide. The optical waveguide may comprise a first end, a second end opposite the first end and comprising an end reflector, a viewing surface extending between the first end and the second end, and a back surface opposing the viewing surface. In one embodiment, the optical waveguide is the optical wedge of FIG. 2, where the thin end of the optical wedge is the first end of the optical waveguide and the thick end of the optical wedge is the second end of the optical waveguide.

In another embodiment, the optical waveguide may have a constant thickness, e.g. the first end and the second end are the same thickness. Such an optical waveguide may include a cladding on the viewing and/or back surface with a refractive index that varies linearly between the first end and the second end. This embodiment will behave similarly to an optical wedge when light is injected into the first end of the optical waveguide. In yet another embodiment, the optical waveguide may have a constant thickness, a refractive index that varies linearly between the first end and the second end, and claddings on the viewing and/or hack surface of constant refractive index. This embodiment will also behave similarly to an optical wedge when light is injected into the first end of the optical waveguide.

Returning to FIG. 10, method 1000 begins at 1010, by injecting light into the first end of the optical waveguide. As described above, the light may be injected by a light source configured to be mechanically moved along the first end of the optical waveguide, for example. In another embodiment, a plurality of light sources may be arranged along the first end of the optical waveguide, each light source configured to inject light into the first end of the optical waveguide at a different location along the first end of the optical waveguide. The light may injected by one or more light sources of the plurality of light sources. In yet another embodiment, the light may be injected by scanning a laser beam across a diffusive screen positioned adjacent to and extending along the first end of the optical waveguide.

Next, at 1020, the injected light is delivered to the end reflector via total internal reflection. At 1030, the light may be internally reflected off of the end reflector. The light internally reflected off of the end reflector may be reflected from a first set of facets and a second set of facets, each of the first set of facets having a normal that points at least partially toward the viewing surface, and each of the second set of facets having a normal that points at least partially toward the back surface. Furthermore, in some embodiments, each of the first set of facets may have an angle of three-eighths of a difference between 90 degrees and the critical angle of reflection and each of the second set of facets may have an angle of three-eighths of the difference between 90 degrees and the critical angle of reflection. In other embodiments, the facets may have other suitable angles that do not cause unsuitable variations in light intensities. In yet another embodiment, the end reflector may include a diffraction grating.

Due to the angle at which facets on the end reflector are angled, at 1040, a portion of light may be emitted from the viewing surface, the portion of light intersecting the viewing surface at a critical angle of reflection. Next, at 1050, the location along the first end of the optical waveguide at which the light is injected into the optical waveguide may be varied. In one embodiment, the location along the first end of the optical waveguide may be varied by mechanically moving a light source to a desired location and then light may be injected at the desired location by the light source. In another embodiment, the location along the first end of the optical waveguide may be varied by selectively illuminating a light source from a plurality of light sources arranged along the first end of the optical waveguide. In yet another embodiment, the location along the first end of the optical waveguide may be varied by scanning a laser across a diffusive screen positioned adjacent to and extending along the first end of the optical waveguide. By varying the location where light is injected, the direction of the light beam may be varied. As illustrated in FIGS. 8 and 9, injecting light into the left side of thin end 110 of optical wedge 100 may emit the collimated light in a direction to the right of optical wedge 100, and vice versa.

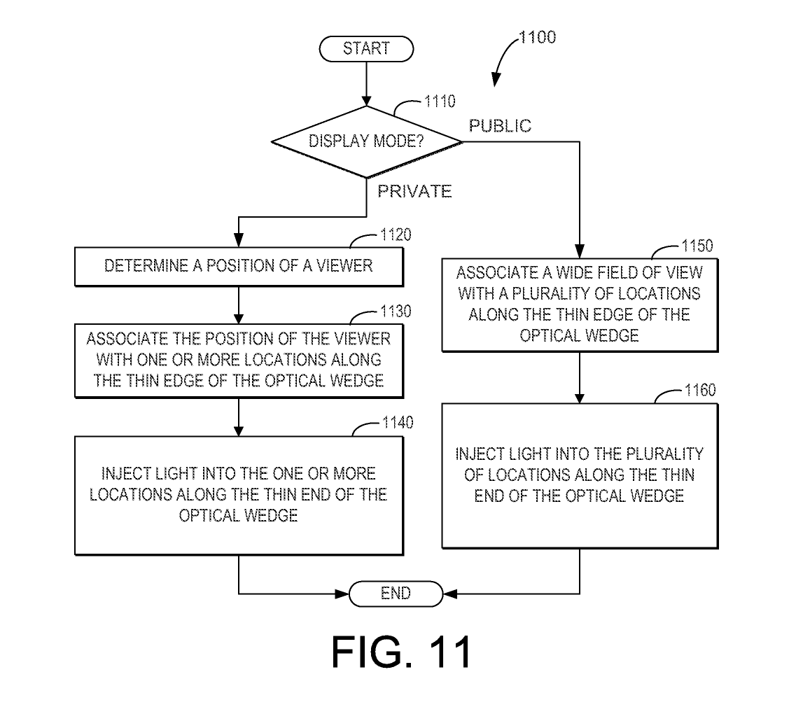

FIG. 11 shows a flowchart of an example embodiment of a method that may be used to carry out a method of using a beam of light to display public and private information during different modes on the same optical system, such as video presentation system 10. Prior to describing FIG. 11, it will be understood that the use of the term “wedge” in the descriptions of FIGS. 11-12 and 16 are not intended to limit applicability of this embodiment to optical wedge light guides, and that a light guide with a varying index of refraction, as described above, also may be used.

Returning to FIG. 11, at 1110, the display mode of the optical device is determined. If the display mode is a public mode, the routine proceeds from 1110 to 1150. If the display mode is a private mode, the routine proceeds to 1120.

When the display mode is private, at 1120, a position of a viewer may be determined. The position of the viewer may be determined by controller 14 using head-tracking data received from head-tracking camera 18 or the position may be assumed to be directly in front of video presentation system 10, for example. At 1130, the position of the viewer may be associated with one or more locations along the thin end of the optical wedge. The locations along the thin end of the optical wedge may be selected such that the viewer is in an optical path of the light beam emitted from video presentation system 10 when light is injected at each of the locations, for example. At 1140, light may be injected into the one or more locations along the thin end of the optical wedge. Injecting light at a single location from a single light source may provide the narrowest field of view of video presentation system 10. However, it may be desirable to widen the field of view by injecting light at more than one location. Widening the field of view may provide margin if the calculated position of the viewer is not exact, such as if the head-tracking algorithm is slow compared to a speed of a viewer's movements, for example. It will be understood that the field of view may be controllable by a user of the display such that a private image may be displayed to any number of users located in any suitable position(s) around the display. The routine ends after 1140.

Method 1100 may be continually repeated in a loop such that the position of the viewer may be updated if the viewer moves. By updating the position of the viewer and the associated location along the thin end of optical wedge, the light beam from video presentation system 10 may follow the viewer as the viewer moves.

When the display mode is public, at 1150, a wide field of view may be associated with a plurality of locations along the thin end of the optical wedge. For example, in some situations, all of the light sources may be illuminated concurrently, or a sub-set of light sources may be illuminated concurrently. In either case, as illustrated at 1160, light is injected into the plurality of locations along the thin end of the optical wedge and an image may be displayed with a wide field of view.

The public mode of the display may be used in different manners to display an image to different numbers of viewers. For example, it may be desirable to display an image to any viewer that may have a direct view of the display screen. In this case, a wide field of view may be obtained by illuminating all light sources of a plurality of light sources arranged along, the thin end of an optical wedge. On the other hand, some uses of the public mode may exhibit certain characteristics of a private display. For example, the display may be configured such that a bank teller and a customer may each see an image that may be concealed to viewers with a different angle of the display than the bank teller or the customer. In such a mode, the directions which to direct the light may be predetermined based upon a seating/standing position of intended viewers, or may be determined by camera or other suitable method.

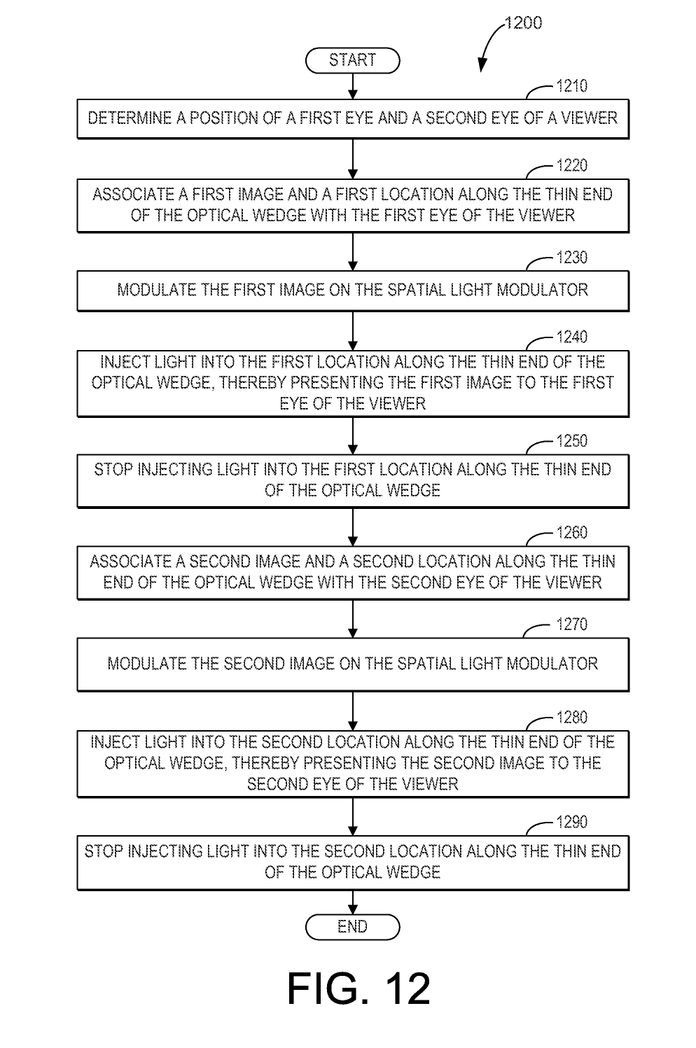

In some embodiments, for each viewer of a private image, a stereoscopic image may be presented by sequentially providing different images to the right and left eyes of the viewer for each frame of video data. For example, in some such embodiments, images are displayed such that each pixel of the display panel is visible to only one eye at any one frame, and then visible to only the other eye in the subsequent frame. In other such embodiments, images may be displayed in any other suitable manner (e.g. with some suitable amount of overlap). FIG. 12 shows a flowchart of an example embodiment of a routine used to carry out a method of displaying autostereoscopic images via directed light. Such a display mode may be referred to herein as an autostereoscopic mode. At 1210, a position of a first eye and a position of a second eye of a viewer are determined via a head-tracking camera. At 1220, a first image and a first location along the thin end of the optical wedge are associated with the first eye of the viewer. The first image may be a view of a three-dimensional object as seen by the left eye of the viewer, for example. The left eye may be in the optical path of the directed light emitted by video presentation system 10 when light is injected at the first location along the thin end of the optical wedge. At 1230, the first image is modulated on spatial light modulator 12 and at 1240, light is injected into the first location along the thin end of the optical edge, thereby presenting the first image to the first eye of the user.

At 1250, the injection of light into the first location along the thin end of the optical wedge is stopped, and at 1260, a second image and a second location along the thin end of the optical wedge are associated with the second eye of the viewer. The second image may be a view of a three-dimensional object as seen by the right eye of the viewer, for example. The right eye may be in the optical path of the light emitted by video presentation system 10 when light is injected at the second location along the thin end of the optical wedge, for example. At 1270, the second image may be modulated on spatial light modulator 12. At 1280, light may be injected into the second location along the thin end of the optical wedge, thereby presenting the second image to the second eye of the user.

At 1290 the injection of light into the second location along the thin end of the optical wedge is stopped. Method 1200 may then be repeated sequentially such that a first set of images are displayed to one eye and a second set of images are displayed to the other eye. If the routine is repeated fast enough, e.g. the refresh rate is high enough, the viewer's eyes may integrate the time-multiplexed images into a flicker-free scene. Each viewer has different perceptions, but refresh rates greater than 60 Hz may be desirable.

Further, the disclosed embodiments of video presentation systems may be used to present a view-dependent rendered image in which a perspective of an object in an image varies as a viewer's perspective of the display screen changes. To create this effect, a plurality of laterally adjacent images may be displayed in quick succession so that each image is visible from a slightly different viewing angle. For example, in one embodiment, the plurality of laterally adjacent images may include 32 images representing 32 views of a scene in two or three dimensions. Since each eye of the viewer views the display at a slightly different angle, each eye may see a different image such that the image viewed is dependent upon the viewer's perspective of the display screen. Likewise, instead of displaying laterally adjacent images continuously, only images that are currently in a user's field of view may be displayed through use of eye-tracking techniques. In addition, multiple viewers may also be provided with such view-dependent rendered images in which each eye of each user is presented with a different image. Such a method may give a viewer or viewers the impression of looking at the displayed image through a window due to the change in perspective as a function of movement of each viewer's head/eye position.

As mentioned above, in some embodiments, the light from the backlight system may be configured to converge at the viewer's eye. Video presentation system 10 in FIG. 1 may enable autostereoscopic viewing when the spatial light modulator 12 is small, e.g. pupil sized. As the size of spatial light modulator 12 increases, video presentation system 10 may comprise additional optical elements, such as a Fresnel lens adjacent to spatial light modulator 12.

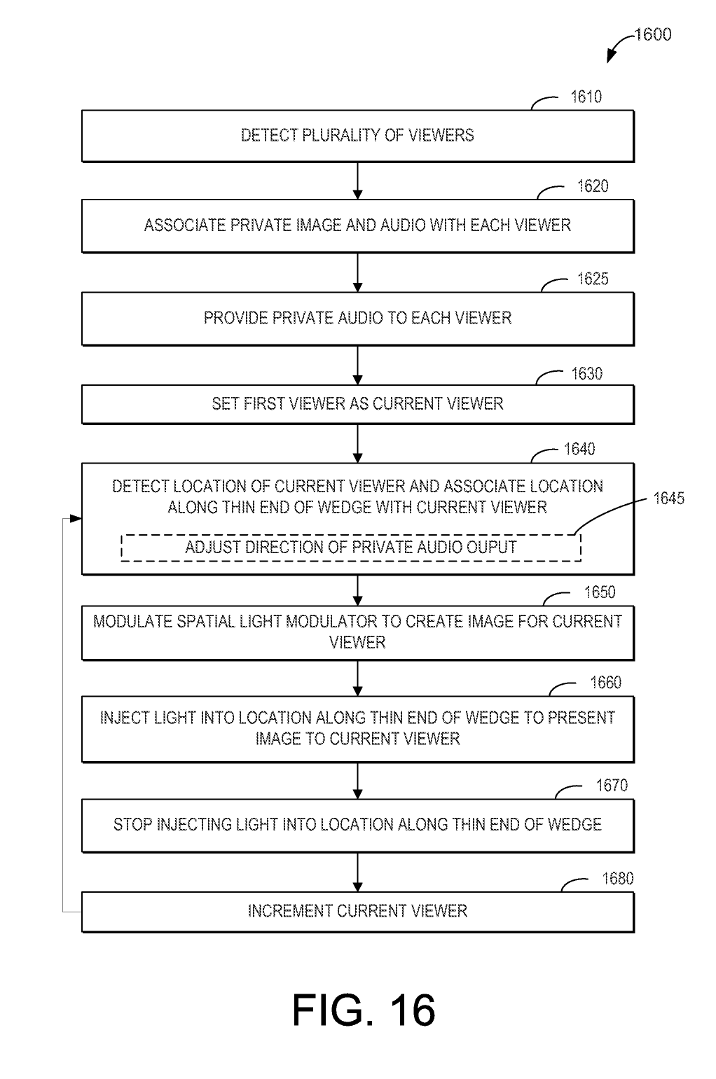

FIG. 16 shows a flowchart illustrating; another embodiment configured to display private video presentations (either the same or different presentations) to multiple viewers concurrently. Method 1600 begins at 1610, where a plurality of viewer are detected, for example, via image sensor data. Then At 1620, private image and audio outputs are associated with each viewer. Any suitable outputs may be associated with each viewer, such as a video content item or a content discovery screen via which a viewer may select a video content item for private consumption.

At 1625, private audio is provided to each viewer. The private audio may be provided in any suitable manner. For example, in some embodiments, each user may utilize a set of wired or wireless headphones that can be linked with a particular viewer. As a more specific example, a wireless headphone set may be configured to emit a line-of-sight signal (e.g. an infrared beacon) upon receipt of a request sent over a wireless communications channel (e.g. Bluetooth, WiFi, or any other suitable wireless communications channel) by the video presentation system. The line-of-sight signal may be detected via by a head-tracking camera, or in any other suitable manner. In another embodiment, user feedback may be used to link a headphone set to a particular user. For example, an audio signal may be sent sequentially to each headphone set requesting each user to perform a gesture that can be detected by the head-tracking camera. In embodiments that utilize directional speakers to output private audio, such headphone association processes may be omitted, as the audio output for a video content item may be directed in the same direction as the video output.

Next, at 1630, method 1600 comprises setting a first viewer as a current viewer. Then, at 1640, a location of the current viewer is determined, and associated with a location along the thin end of the optical wedge that will result in the light being directed to the current viewer. The current viewer location may be determined in any suitable manner. For example, the location may be determined by using head-tracking data, may be predetermined (e.g. a number of and/or locations of positions may be controlled and/or set by a user or administrator) etc. It will be understood that the location at which light is injected for a particular user may be adjusted between iterations as a viewer moves within the viewing environment as tracked via the head-tracking camera. Likewise, the direction of a private audio output, such as an audio beam, may be adjusted if the user has moved, as indicated at 1645.

Next, at 1650, the spatial light modulator is modulated to create an image for the current viewer. In some cases, the image may also be associated with other viewers so that multiple viewers may see the same image, while in other cases the image may be associated with a single viewer.

At 1660, method 1600 comprises injecting light into thin end 110 of optical wedge 100, thereby presenting the image to the current viewer. Then, at 1670, the injection of light into thin end 110 of optical wedge 100 is stopped. At 1680, the current viewer number is incremented and then the method continues at 1640. In this manner, multiple video presentations may be presented to multiple users concurrently. If the refresh rate is high enough, a viewer's eyes may integrate the time-multiplexed images associated with that viewer into a flicker-free image. Each viewer has different perceptions, but refresh rates greater than 60 Hz may be suitable. Processes 1640-1680 may loop until all viewers have elected to cease viewing, at which time method 1600 may end.

In some embodiments, even as a user stops viewing the display (e.g. turns to face a different direction), private audio may continue to be provided until it is determined that the user has left a viewing experience (e.g. by being unattentive for a predetermined period of time). Likewise, where users receive private audio via wireless headphones, private audio may continue to be provided to a user even when the user is out of view of the user tracking camera. This may allow a video presentation to be tracked while stepping briefly out of the room, for example.

In some of the above-described embodiments, illuminated areas associated with each eye of each user are projected out into space according to a user's position as detected by a camera such as a depth sensor or a conventional camera, while in other embodiments, a single image is projected that is viewable by both eyes of a viewer. The relative locations of the camera and the display may be fixed, but due to mechanical tolerances, some difference may exist between where the camera thinks the viewer is and where the display thinks it is sending the light. As the display produces time sequential illumination, a camera that operates at a frame rate of the display may be used to look at the viewer during operation to see illumination from the display system projected onto the face of the viewer. This may be used to calibrate the projection. For example, when a left-eye image is projected to the viewer, only the left eye should be illuminated by the display. Thus, by matching the position of the eyes/head as seen by the camera with the left/right differential images seen sequentially by the same camera, calibration errors may be detected and compensated for.

The additional illumination on each eye may be less than ambient. Thus, to enhance the detectability of the display images, some non-visible (e.g. infrared) component may be added to the visible light. As the transmission of liquid crystal displays may be higher in the infrared than in the visible (in some cases, 10× higher), the additional component may comprise a small fraction of total illumination. Then, over time, as the user moves around the display, the calibration between the camera and the display may be adaptively refined. It will be appreciated that, if the visible light images are sufficiently detectable, such an infrared illuminant may be omitted.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable storage media may be provided having program instructions stored thereon, which upon execution by a computing device, cause the computing device to execute the methods described above and cause operation of the systems described above.

It will be understood that the specific configurations and/or approaches described herein for scanning directed light are presented for the purpose of example, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A video presentation system, comprising:
a display surface;
a directional backlight system configured to emit a beam of light from the display surface and to vary a direction in which the beam of light is directed;
a spatial light modulator configured to form an image for display via light from the directional backlight system; and
a controller configured to control the directional backlight system and the spatial light modulator to display a first video content item at a first viewing angle and a second video content item at a second viewing angle.

2. The video presentation system of claim 1, further comprising a private audio output controllable by the controller to provide a first private audio output corresponding to the first video content item and to provide a second private audio output corresponding to the second video content item.

3. The system of claim 1, wherein the directional backlight system comprises:
an optical waveguide; and
a plurality of light sources arranged along an end of the optical waveguide, each light source configured to inject light into the end of the optical waveguide at a different location along the end of the optical waveguide.

4. The system of claim 3, wherein the controller is configured to sequentially illuminate two or more light sources of the plurality of light sources to modulate a direction in which the beam of light is emitted.

5. The system of claim 1, further comprising a user-tracking camera, and wherein the controller is further configured to receive data from the user tracking camera, to locate a first viewer and a second viewer via the data, and to sequentially direct the beam of light toward the first viewer and then the second viewer while synchronously modulating the spatial light modulator.

6. The system of claim 4, wherein the controller is configured to modulate a direction of the beam of light in synchronization with the spatial light modulator to create stereoscopic images for each viewer of one or more viewers.

7. The system of claim 4, wherein the controller is configured to detect a change in a location of the first viewer and to adjust a direction of the beam of light based upon the change in the location of the first viewer.

8. A video presentation system, comprising:
a display surface;
a directional backlight system system configured to emit a beam of light from the display surface and to modulate a direction in which the beam of light is directed;
a spatial light modulator configured to form an image for display via light from the directional backlight system;
a controller configured to control the directional backlight system and the spatial light modulator to display a first video content item at a first viewing angle and a second video content item at a second viewing angle; and
a private audio output controllable by the controller to provide a first private audio output corresponding to the first video content item and to provide a second private audio output corresponding to the second video content item.

9. The system of claim 8, wherein the directional backlight system comprises:
an optical waveguide comprising a first end, a second end opposite the first end, a viewing surface extending at least partially between the first end and the second end, and a back surface opposite the viewing surface, and an end reflector disposed at the second end of the optical waveguide, the end reflector comprising one or more of a faceted lens structure and a diffraction grating; and
a plurality of light sources arranged along the first end of the optical waveguide, each light source configured to inject light into the first end of the optical waveguide at a different location along the first end of the optical waveguide.

10. The system of claim 9, wherein the controller is configured to sequentially illuminate two or more light sources of the plurality of light sources to modulate a direction in which the beam of light is emitted.

11. The system of claim 8, further comprising a user tracking camera, and wherein the controller is further configured to receive data from the user tracking camera, to locate a first viewer and a second viewer via the data, and to sequentially direct the beam of light toward the first viewer and then the second viewer while synchronously modulating the spatial light modulator.

12. The system of claim 11, wherein the controller is configured to modulate a direction of the beam of light in synchronization with the spatial light modulator to create stereoscopic images for each viewer of a plurality of viewers.

13. The system of claim 11, wherein the controller is configured to detect a change in a location of the first viewer and to adjust a direction of the beam of light based upon the change in the location of the first viewer.

14. The system of claim 8, wherein the private audio output comprises a wireless transmitter, wherein the first private audio output comprises a first wireless headphone signal corresponding to the first video content item and wherein the second private audio output comprises a second wireless headphone signal corresponding to the second video content item.

15. The system of claim 8, wherein the private audio output comprises one or more of a directional speaker and a phased array speaker, and wherein the first private audio output comprises a first audio beam and the second private audio output comprises a second audio beam.

16. The system of claim 8, further comprising a plurality of video content source inputs, and wherein the controller is configured to multiplex image data received from the plurality of video content source inputs for provision to the spatial light modulator.

17. A method of concurrently providing different audio/video presentations to different viewers via a video presentation system comprising an optical waveguide, a spatial light modulator, and a private audio output system, the optical waveguide comprising a first end, a second end opposite the first end, a collimating end reflector located at the second end, a viewing surface extending between the first end and the second end, a back surface opposing the viewing surface, the method comprising:
injecting light into the first end of the optical waveguide;
delivering the light to the end reflector via total internal reflection;
internally reflecting the light off of the end reflector, thereby collimating the light;
emitting the light from the viewing surface;
varying a location along the first end of the optical waveguide at which light is injected into the optical waveguide;
switching images produced by the spatial light modulator between a first video content item and a second video content item in synchronization with varying the location at which light is injected into the optical tide;
providing a first audio output corresponding to the first video content item; and
providing a second audio output corresponding to the second video content item.

18. The method of claim 16, wherein providing the first audio output comprises providing the first audio output to a first wireless headphone set and providing the second audio output to a second wireless headphone set.

19. The method of claim 16, wherein the first audio output comprises a first audio beam and wherein the second audio output comprises a second audio beam.

20. The method of claim 16, further comprising: a location of a first viewer and a location of a second viewer via image data; and
varying the location at which light is injected into the optical waveguide by modulating between a first light injection location and a second light injection location based upon the location of the first viewer and the location of the second viewer.
